(19) United States
(12) Patent Application Publication
(10) Pub. No.: US 2026/0126069 A1
(43) Pub. Date: May 7, 2026

(54) AXIAL TOLERANCE COMPENSATION ARRANGEMENT, A CONNECTION BETWEEN TWO COMPONENTS WITH SAME AS WELL AS A CONNECTION AND A MANUFACTURING METHOD FOR SAME

(71) Applicant: Böllhoff Verbindungstechnik GmbH, Bielefeld (DE)

(72) Inventor: Gunnar LINDNER, Paderborn (DE)

(21) Appl. No.: 19/380,571

(22) Filed: Nov. 5, 2025

(30) Foreign Application Priority Data
Nov. 6, 2024 (DE) 102024132390.6

(51) Int. Cl. F16B 5/02

(52) U.S. Cl. CPC F16B 5/025; F16B 5/0233

(57) ABSTRACT

An axial tolerance compensation arrangement for the automatic compensation of tolerances between a first and a second component including: a nut element with a radially outer fastening structure, which is fastenable in a component opening of the first component, and an inner nut thread of a first thread direction, a hollow screw with a head at a first axial end of the hollow screw and a hollow-cylindrical shaft having an adjusting thread at a radial outside matching the nut thread and at a radial inside a fastening thread with a second thread direction opposite to the first thread direction. The fastening thread interacts with a fastening screw of a second thread direction so that the first and the second component are fastenable via the tolerance compensation arrangement. The fastening thread includes a dragging element that connects the fastening screw with the hollow screw using a releasable dragging connection.

### 1. FIELD OF THE INVENTION

The present invention is related to an axial tolerance compensation arrangement for the automatic compensation of axial tolerances between a first and a second component, a connection between these two components with the help of the axial tolerance compensation arrangement, a respective connection method as well as a manufacturing method for the axial tolerance compensation arrangement.

### 2. BACKGROUND OF THE INVENTION

In the state of the art, different tolerance compensation arrangements are known, with the help of which two components are fastenable at a distance to each other. These tolerance compensation arrangements follow different technical principles.

In order to realize an automatic axial tolerance compensation between two components during them being connected, the state of the art suggests tolerance compensation arrangements where thread pairings of a different thread direction and a dragging element are combined with each other. They are for example described in EP 2 049 807 B1, DE 10 2020 216 324 A1, EP 1 780 424 A1. It is particularly the integration of a dragging arrangement into two interconnected thread sleeves with different thread pairings which increases the manufacturing effort of such axial tolerance compensation arrangements, as often, the dragging element is made of another material than the thread sleeves which are to be connected with one another. Nonetheless, the advantage of these arrangements is that they are integrable into the process of connecting without any additional installation effort as when fastening the components which are spaced from each other, the tolerance compensation arrangement compensates the distance between the two components in a supportive, automatic and subsequently mechanically loadable manner.

From DE 10 2007 037 242 A1, a fastening device for fastening a first component to a second component with automatic compensation of tolerances in the distance between the two components is known. This device comprises a base unit consisting of a blind rivet nut which is attachable to the first component, an adjusting thread nut and a sleeve-like cage which receives the adjusting thread nut and connects it with the blind rive nut, an adjustment unit consisting of a thread sleeve, an attachment plate and a dragging bushing which connects the thread sleeve and the attachment plate, wherein the thread sleeve of the adjustment unit is screwable into the adjusting thread nut of the base unit by means of a first thread pairing of a first thread direction, and a fastening screw which is screwable by means of a second thread pairing of an opposite second thread direction into the blind rivet nut which is attached to the component and forms a releasable dragging connection with the dragging bushing, so as to co-rotate the adjustment unit when rotating the fastening screw and by that to move the attachment plate for the purpose of tolerance compensation in abutment with the second component.

A disadvantage of these arrangements is that due to the necessary dragging element as an individual component, the construction of tolerance compensation arrangements is overall complex and the manufacturing effort is increased.

Therefore, in the course of an embodiment, DE 10 2020 216 324 A1 suggests that the dragging element be integrated into the inner thread of the compensation element adjacent to the attachment portion. The integration may take place by means of providing a coating of the inner thread, by means of a thread tapering in the downward direction, by means of deformation of the inner thread and/or by interruptions/defective spots in the inner thread.

Finally, from EP 2 980 421 A1, an adjustment element for compensating a gap between a carrier and a part to be fastened at the carrier is known, consisting of a hollow body provided with an outer thread of a first pitch direction. The hollow body comprises an inner thread with a second pitch direction contrary to the first one, with the inner thread comprising at least two thread turns and at least one of these thread turns is deformed in order to provide a higher friction torque than that provided by the other thread turns of the inner thread. Deformed thread refers to a thread which comprises at least one part which has been deformed in order to be led closer to a neighboring thread. That means, the distance between the deformed thread and the neighboring thread is less than the pitch of the inner thread.

By approaching the deformed thread to the neighboring thread, a friction torque arises which is larger than that provided by the other non-deformed thread turns of the inner thread.

A disadvantage of these arrangements with integrated dragging function is that the torque for overcoming the integrated dragging function is often larger than in case of known arrangements with separate dragging element, so that a further screwing-in of a fastening screw after the effected tolerance compensation is unnecessarily difficult at least in the beginning. Furthermore, the fastening of the tolerance compensation arrangement in the first component is time consuming and complex when it comes to the above discussed arrangements.

It is therefore the object of the present invention to provide a tolerance compensation arrangement which overcomes the above disadvantages and is optimized in this respect. Likewise, a corresponding connection as well as a connection method and manufacturing method should be provided.

### 3. SUMMARY OF THE INVENTION

The above object is solved by a tolerance compensation arrangement according to the independent claim 1, by a connection between a first and a second component with the tolerance compensation arrangement according to the independent claim 10, by a connection method of two components with this tolerance compensation arrangement according to the independent claim 12 and by a manufacturing method of the above-mentioned tolerance compensation arrangement according to claim 13. Advantageous configurations and further developments of the present invention arise from the following description, the accompanying drawings and the appending claims.

The present invention discloses an axial tolerance compensation arrangement for the automatic compensation of tolerances between a first and a second component, having the following features: a nut element, preferably an annular nut element, with a radially outer fastening structure, in particular a bayonet structure, which is fastenable in a component opening, in particular a keyhole geometry, of the first component, and an inner nut thread of a first thread direction, a hollow screw with a head at a first axial end of the hollow screw and a hollow-cylindrical shaft having an adjusting thread at a radial outside matching the nut thread and at a radial inside a fastening thread with a second thread direction opposite to the first thread direction, wherein the fastening thread interacts with a fastening screw of a second thread direction so that the first and the second component are fastenable to one another by means of the tolerance compensation arrangement, wherein the fastening thread comprises, preferably adjacent to a second axial end of the hollow screw, a dragging means, so that the fastening screw is connectable with the hollow screw via the dragging means by means of a releasable dragging connection, wherein a dragging torque is preferably ≤0.2 Nm, particularly preferred ≤0.1 Nm, so that when rotating the fastening screw, the hollow screw is co-rotatable and movable into abutment with the second component and the fastening screw is screwable further into the hollow screw after overcoming the dragging torque and releasing the dragging connection.

The present invention provides an axial tolerance compensation arrangement which, on the basis of two thread pairings of a different thread direction, provides an automatic tolerance compensation when being installed between two components that are spaced from one another. In order to simplify and thus accelerate the establishment of this connection between the two components already at the beginning of the installation process, the nut element for receiving the tolerance compensating hollow screw is anchored in a keyhole geometry or in a keyhole of the first component. That way, a resilient thread basis is created with the help of the nut element and the bayonet lock to the first component used in combination with same or the bayonet connection to the first component used in combination with same so as to be able to fasten the second component at a specific distance to it. This fastening process of the nut element with bayonet structure, which most of the time only requires a quarter turn, is easier than for example the use of a blind rivet nut or a welding nut in terms of manufacturing and application, in order to be able to establish a connection between two components.

In an alternatively preferred configuration, the radially outer fastening structure of the nut element is provided by an outer thread. In this context, it is particularly preferred that same is a thread-forming or thread-grooving outer thread, because that way, a reliable connection particularly with a first component out of a plastic material can be established. In comparison with the above-discussed bayonet structure, which enables an anchoring of the nut element in a thin-walled component, the nut element with the outer thread requires a comparably more thick-walled component as a radial outer fastening structure, or an overhang needs to be present around the component opening. Both alternatives guarantee that there is sufficient area for the engagement with the outer thread at the component opening of the first component.

With regard to a further alternative configuration, the radially outer fastening structure is formed by a latching structure with radially springing locking noses. Preferably, in this configuration, the nut element comprises at least one axially extending, rigid web at the radial outside in order to prevent a rotating of the nut element in the first component in use. For this purpose, the at least one rigid web interacts with a corresponding recess in the component opening of the first component. In this context, a mutual arrangement of locking noses and rigid webs is particularly advantageous. For example, two locking noses and two rigid webs can be arranged opposite one another while an angle of 90° is enclosed between a locking nose and the adjacent rigid web. A nut element configured that way can be anchored in a keyhole geometry or in a keyhole of the first component, just like the above discussed bayonet connection. Accordingly, same is preferably a thin-walled first component.

If the component opening of the first component is located at an edge of the first component, e.g. in the form of a U-shaped recess, the radially outer fastening structure of the nut element can be provided by means of lateral locking noses. For this purpose, the nut element has a U-shaped body formed complementary to the U-shaped recess, wherein at the radial outsides of the respective legs of the U-form, a locking nose is provided which interacts with a corresponding recess in the component opening in the first component. In this case, the inserting of the nut element into the component opening does not take place in axial direction but rather from the side. Analogously to the explanations regarding the outer thread as fastening structure, an overhang or collar must be provided at the component opening so that the nut element can be fastened reliably.

Finally, in addition to the radially outer fastening structure of each design, the nut element can comprise a flange with a sealing lip extending from same in axial direction and extending circumferentially. In use, the sealing lip lies around the component opening on a surface of the first component and hinders media from entering through the component opening. In order to additionally guarantee that no media can enter through the component opening and in particular through the hollow screw from the one component side to the other component side, the nut element is preferably configured with one closed side.

The different design possibilities of the radially outer fastening structure are clarified later with reference to the detailed embodiments. The same also applies to the configuration with flange and sealing lip.

In order to compensate the existing distance between the two components, a hollow screw is arranged, preferably pre-installed, in the nut element. The fastening thread of the hollow screw comprises the dragging means. Thus, it is a dragging means that is integrated into the hollow screw. A separate dragging element or an independent dragging element, respectively, as it is known from the state of the art, is therefore not present.

Advantageously, the dragging means is arranged adjacent to the second axial end of the hollow screw. As the first axial end of the hollow screw comprises the head, the dragging means is present remote from the head. When using the tolerance compensation arrangement, the fastening screw is screwed into the fastening thread from the first axial end. That means that the fastening screw engages the fastening thread of the hollow screw with the dragging means only at the end of the screwing process.

As explained above, the dragging means is integrated into the fastening thread, i.e. it is present in the portion of the fastening thread. This is particularly important with respect to embodiments which at the second axial end of the hollow screw have a larger inner diameter in comparison with the portion with the fastening thread. In such cases, the wording adjacent to the second axial end refers to the portion with the fastening thread. This will be clarified later when the preferred embodiments are explained as well as in the detailed description.

The dragging means provides a dragging torque. Preferably, it is dimensioned in a way that it is larger than a releasing torque between adjusting thread and nut thread. In comparison with the state of the art with an integrated dragging element, the dragging torque provided by the dragging means does, however, not lead to an excessive force increase in order to release the dragging connection and screw the fastening screw further into the hollow screw. This is emphasized particularly by the preferred amount of the dragging torque, which is ≤0.2 Nm, preferably ≤0.1 Nm.

Thus, the advantages of the inventive tolerance compensating arrangement are that due to the nut element, it is fastenable easily and quickly in the first component. Furthermore, a separate dragging element is not necessary so that complexity of the tolerance compensation arrangement is reduced. Moreover, the dragging torque is dimensioned such that no significantly increased force effort for releasing the dragging connection is necessary, which facilitates use even more. In a preferred embodiment of the tolerance compensation arrangement, the dragging means adjacent to the second axial end of the hollow screw, in particular in a portion ≤360° of the course of the fastening thread beginning at or adjacent to the second axial end is provided by the fact that a depth of the fastening thread decreases, and/or that the fastening thread is configured at least partly with interruptions and/or the radial inside of the hollow screw adjacent to the second axial end is configured in part or completely even circumferentially and in axial direction.

As indicated above, the wording adjacent to the second axial end mainly refers to embodiments where the hollow screw comprises at least two portions with different inner diameter, each. A first portion adjacent to the head and thus to the first axial end comprises for example a first inner diameter as well as the fastening thread. A second portion with a larger second diameter is provided adjacent to the second axial end. Same can therefore not define the fastening thread and remains unconsidered when viewing the dragging function.

For this purpose, the wording that the dragging element is present in a portion ≤360° of the course of the fastening thread beginning at or adjacent to the second axial end solely refers to the portion with fastening thread, i.e. based on the above example to the first portion, that is the fastening portion. This is supposed to highlight that in screwing direction of the fastening thread, the dragging means is present at the end of the fastening thread.

Furthermore, from the feature of the course of ≤360° of the fastening thread depending on the thread pitch, the maximum axial extension of the section arises where the dragging means is present. If, for example, there is a thread pitch of 1.75 mm, the axial extension of the section where there is the dragging means will correspond to 1.75 mm.

The different preferred configurations of the dragging means all realize an effective dragging connection between hollow screw and fastening screw. However, due to the different configurations, the dragging torque can be adapted specifically to the used materials.

Based on the above example, the configuration where the radial inside is configured circumferentially and in axial direction partly or completely even refers to the first portion, i.e. the portion with the fastening thread. A possibly present second portion with a larger inner diameter is not characterized by that, as with this configuration, it should be made clear that the fastening thread was not formed up to the end of the fastening portion. Rather, the fastening screw must groove or cut a part of the fastening thread itself before a front end of the fastening screw, i.e. an end which faces away from the head, leaves the portion with the fastening thread.

According to an example, axial webs follow the portion having the formed fastening thread. For example, three axial webs are provided which are circumferentially spaced evenly from each other.

Between the axial webs, the wall in the fastening portion springs back radially. In other words, the axial webs project in radial direction from the wall in the fastening portion. Here, the projection in radial direction is dimensioned in a way that the fastening screw comes into engagement with the axial webs. As the axial webs are, however, configured even, the fastening screw must produce a thread in the axial webs. In this configuration and with reference to the above wording, the radial inside is configured circumferentially and in axial direction partly even.

Preferably, the axial webs have a trapezoid design in cross section. Here, the longer base side of the trapezoid shape is arranged radially outside while the shorter base side is arranged radially inside and provides the portion with which the fastening screw comes into engagement in use.

In particular, the axial webs which are configured that way provide the dragging means for the automatic dragging of the hollow screw on the one hand. Only after having overcome the dragging torque does the fastening screw produce a thread in the axial webs. Furthermore, the axial webs can also serve as a further drive means for a manual adjustment of the hollow screw. An adaptation of the dragging torque is possible by varying the number of webs and/or their extension in circumferential direction. This will also be explained further with respect to the detailed description.

In an advantageous embodiment of the tolerance compensation arrangement, same furthermore comprises a transport security, so that during a transport of the tolerance compensation arrangement, an unintended screwing-out of the hollow screw from the nut element is prevented. Preferably, in doing so, the transport security additionally provides a first anti-counter security between the hollow screw and the nut element. It is particularly advantageous that for doing so, the nut element provided a nose projecting in axial direction, which in combination with a transport security contour forms the transport security at a radial outside of a shaft-facing attachment surface at the head of the hollow screw. In this respect, it is preferred that the transport security contour does not project beyond the head in radial direction in a first circumferential partial portion, does not project beyond a circle encompassing the head form in a second circumferential partial portion and projects beyond the encompassing circle in a third circumferential partial portion.

Particularly due to the combination of the nose projecting in axial direction with the transport security at the hollow screw, a countering between hollow screw and nut element is prevented beside the transport security, i.e. the security against an unintended unscrewing of the hollow screw from the nut element. The reason for that is the width of the nose, i.e. its extension in circumferential direction, and the resulting attachment surface at the transport security contour, because in the screwed-in state of the hollow screw into the nut element, the nose preferably attaches the transport security contour, it is, however, preferably not deviated in radial direction.

Here, deviated in radial direction refers to the state where the nose, in comparison with its initial condition, is pushed radially further to the outside due to the transport security contour. Here, the starting point is that the first, the second and the third circumferential partial portion are arranged one after the other in circumferential direction. For example, when the hollow screw is in the screwed-in state, the nose is arranged in radial direction adjacent to the transport security contour or attaches same. For example, this can be the case in the second circumferential partial portion of the transport security contour or in a transition portion between the second and third circumferential partial portion, depending on the positioning of the nose in radial direction. It is preferred that in this state, the nose is not deviated radially, i.e. the transport security contour does not push the nose radially to the outside.

If the hollow screw is now unscrewed from the nut element, the nose comes into engagement with the third circumferential partial portion. By that, the nose is deviated radially or pushed to the outside, so that screwing out the hollow screw becomes more difficult. In the further course of the screwing-out, the nose reaches the portion of the first circumferential partial portion. This portion is, however, dimensioned in a way that it does not push the nose radially to the outside anymore. Thus, the nose can return into its initial state. A further screwing-out of the hollow screw does no longer lead to an engagement between nose and transport security contour in axial direction due to the thread pitch and the matching dimensioning of the nose. Accordingly, the extension of the nose in axial direction is preferably chosen such that at the latest after a complete or full turn of the hollow screw, the transport security contour can no longer come into engagement with the nose.

In a further preferred embodiment of the tolerance compensation arrangement with transport security contour, a second anti-counter security between hollow screw and nut element is provided. Preferably, the second anti-counter security is formed in that adjacent to the first axial end of the hollow screw, the adjusting thread does not end in a continuous manner and/or in that adjacent to a first axial end of the nut element, the nut thread of the nut element does not end in a continuous manner. In doing so, the second anti-counter security preferably provides a resistance torque which is preferably larger than the dragging torque. Thus, an additional security against countering is provided by means of the second anti-counter security.

According to a further preferred embodiment of the tolerance compensation arrangement, the annular nut element and the hollow screw are made of plastic material and preferably comprise a glass fiber ratio in the range from 25% to 65%, preferentially 45% to 55% and preferably 50%.

For the purpose of a cost-efficient design of the axial tolerance compensation arrangement, same is preferably made of plastic material by means of a likewise preferred injection molding method. Known plastic materials, e.g. thermoplastic plastic materials, are mechanically sufficiently resilient so as to be able to serve as a tolerance compensation arrangement. The degree of the mechanical load can additionally be increased by adding a glass fiber ratio to the thermoplastic plastic materials. That way, production and distribution costs can be reduced as the production of tolerance compensation arrangements out of plastic material is lower in price than for example a tolerance compensation arrangement out of metal or a combination of plastic material and metal. Furthermore, the weight of a tolerance compensation arrangement out of plastic material is less than that of the same construction out of metal, for example. This has an effect on subsequent transport and delivery costs but also on the weight of the final connection of the two components when using the axial tolerance compensation arrangement.

With respect to the tolerance compensation arrangement, it is furthermore of advantage when same comprises a disassembling protection, as is described in the German patent application DE 10 2024 132 374.4 which was also filed today.

Furthermore, the present invention also discloses a connection of a first component and a second component spaced from same, with the tolerance compensation arrangement according to at least one of the above-described configurations and a fastening screw.

According to a further preferred configuration of the connection, the first component has a keyhole geometry in which the nut element is arranged.

Furthermore, the present invention discloses a connection method of a first component with a keyhole geometry with a second component spaced from same with a component opening having a tolerance compensation arrangement according to one of the above-described configurations or a combination of same, comprising the following steps: fastening the annular nut element, having the hollow screw preassembled in it, in the keyhole geometry of the first component, arranging the component opening of the second component opposite to the fastening thread of the hollow screw and screwing in a fastening screw which extends through the component opening into the fastening thread, rotating the fastening screw and by that, corotating the hollow screw until same abuts the second component and tightening the fastening screw in the fastening thread when the head of the hollow screw rests against the second component.

Furthermore, the present invention comprises a manufacturing method of the tolerance compensation arrangement according to one of the above configurations comprising the following steps: providing an injection mold for the nut element and for the hollow screw, injection molding the nut element and the hollow screw, demolding the nut element and the hollow screw, pre-installing the hollow screw in the nut element.

### 4. SHORT SUMMARY OF THE DRAWINGS

In the following, the present invention will be described in detail based on the drawings. In the drawings, the same reference signs refer to the same components and/or elements. They show:

FIG. 1 a perspective exploded view of a preferred configuration of the inventive tolerance compensation arrangement,

FIG. 2 a perspective view of the hollow screw according to FIG. 1,

FIG. 3 a sectional view of the hollow screw according to FIG. 1,

FIG. 4 a top view on the hollow screw according to FIG. 1,

FIG. 5 a perspective view of the nut element according to FIG. 1,

FIG. 6 a perspective view of the tolerance compensation arrangement according to FIG. 1 in a pre-installed state,

FIG. 7 a sectional view of the tolerance compensation arrangement according to FIG. 6,

FIG. 8 a perspective view of a first component with a keyhole geometry for receiving and fastening the nut element,

FIG. 9 a perspective view of the first component according to FIG. 8 with tolerance compensation arrangement according to FIG. 1 fastened in same,

FIG. 10 a perspective view of the first component with tolerance compensation arrangement according to FIG. 9 in connection with a second component and a fastening screw,

FIG. 11 a lateral view of the connection between two components by means of the tolerance compensation arrangement and the fastening screw,

FIG. 12 a sectional view of the illustration of FIG. 11,

FIG. 13a a top view on a tolerance compensation arrangement according to FIG. 1 with the hollow screw in a completely screwed-in state,

FIG. 13b a perspective view of the state according to FIG. 13a,

FIG. 14a a top view on a tolerance compensation arrangement according to FIG. 1 in 5 with the hollow screw in an initial, unscrewed state,

FIG. 14b a perspective view of the state according to FIG. 14a,

FIG. 15a a top view on a tolerance compensation arrangement according to FIG. 1 with the hollow screw in a further unscrewed state,

FIG. 15b a perspective view of the state according to FIG. 15a,

FIG. 16a a top view on a tolerance compensation arrangement according to FIG. 1 with the hollow screw in a state of being unscrewed even further,

FIG. 16b a perspective view of the state according to FIG. 16a,

FIG. 17 a perspective view of a tolerance compensation arrangement with disassembling protection,

FIG. 18 an enlarged view of the second axial end of the hollow screw of FIG. 17,

FIG. 19 a flow chart of a preferred embodiment of a connection method by using the axial tolerance compensation arrangement,

FIG. 20 a flow chart of a preferred embodiment of a manufacturing method of the inventive axial tolerance compensation arrangement,

FIG. 21 a perspective view of an alternative configuration of the hollow screw,

FIG. 22 a sectional view of an embodiment of an inventive tolerance compensation arrangement with the hollow screw according to FIG. 21,

FIG. 23 a perspective, exploded view of a further preferred configuration of the inventive tolerance compensation arrangement with first component,

FIG. 24 a sectional view of the embodiment of the inventive tolerance compensation arrangement according to FIG. 23,

FIG. 25 a perspective, exploded view of a further preferred configuration of the inventive tolerance compensation arrangement with first component,

FIG. 26 a sectional view of the embodiment of the inventive tolerance compensation arrangement according to FIG. 25,

FIG. 27 a perspective exploded view of a further preferred configuration of the inventive tolerance compensation arrangement with first component,

FIG. 28 a sectional view of the embodiment of the inventive tolerance compensation arrangement according to FIG. 27,

FIG. 29 a perspective, exploded view of a further preferred configuration of the inventive tolerance compensation arrangement with first component,

FIG. 30 a perspective view of the embodiment of the inventive tolerance compensation arrangement according to FIG. 29 when being used in the first component and

FIG. 31 a sectional view of the embodiment of the inventive tolerance compensation arrangement according to FIG. 30.

### 5. DETAILED DESCRIPTION OF PREFERRED EMBODIMENTS

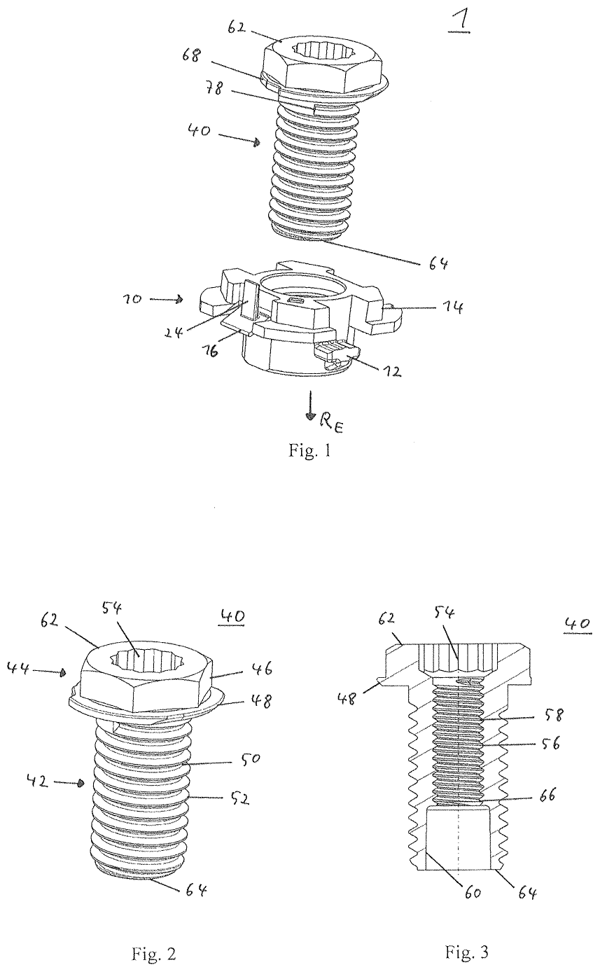

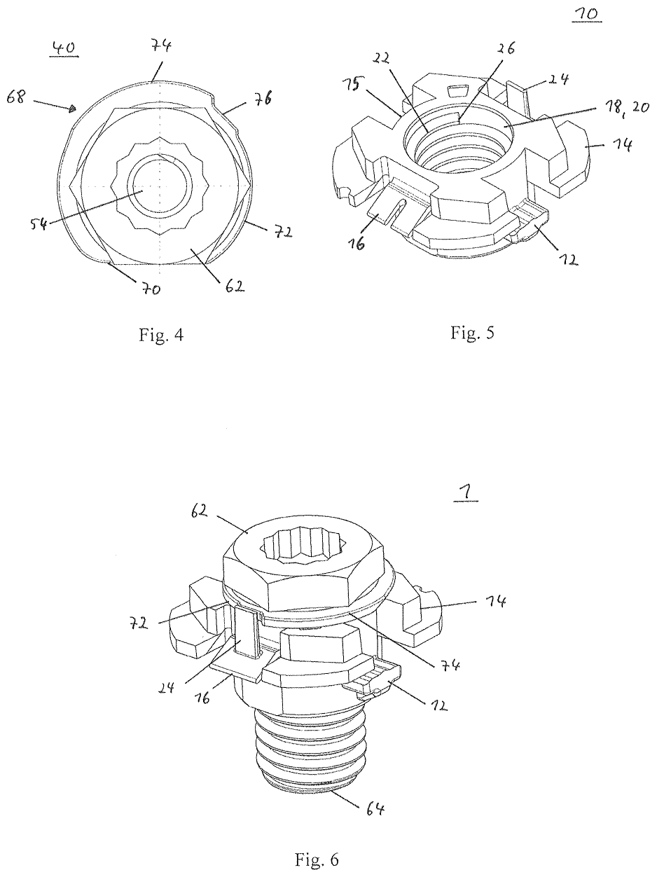

Firstly, with reference to FIGS. 1 to 7, the construction of an embodiment of an inventive tolerance compensation arrangement 1 is explained. Here, FIG. 1 shows an exploded view of the axial tolerance compensation arrangement 1 comprised of a nut element 10 and a hollow screw 40. For fastening a first A and a second component B to each other by using the tolerance compensation arrangement 1, a fastening screw 80 with a disc 86 arranged under the head of the fastening screw 80 is used.

The nut element 10 and the hollow screw 40 are preferably manufactured out of plastic material with the help of an injection molding method. Both the fastening screw 80 and the disc 86 are preferably made of metal. In order to increase a mechanical resilience of the plastic parts of the axial tolerance compensation arrangement 1, a glass fiber ratio of 25% to 65%, preferably of 45% to 55% and further preferred of 50% is added to the plastic material used during the injection molding.

Preferably, the nut element 10 is configured annularly in order to fasten same in a suitable component opening O1 of a first component A. According to the illustrated preferred configuration in FIG. 1, the nut element 10 has a bayonet structure which is described in detail below, with which it is fastenable in a keyhole geometry 90 of the first component A. For this purpose, in the known manner, the keyhole geometry 90 has at least two cutouts 92 which are arranged circumferentially in an evenly distributed manner. The cutouts 92 are adapted to the nut element 10 so that two bayonet webs 12 which extend radially from the nut element 10 to the outside are insertable through the cutouts 92 so that they are then capable of locking the nut element 10 at the first component A by means of rotation. In the fastened stated, the first component A is frictionally held between the bayonet webs 12 and a bottom side of a retaining collar 14 of the nut element 10, wherein the retaining collar 14 is axially spaced to the bayonet webs 12. The first component A with the component opening O1, having a keyhole geometry 90 with the cutouts 92, is shown in FIG. 8. FIG. 9 shows the first component A with the axial tolerance compensation arrangement 1 fastened in it.

At least one locking web 16 is arranged preferably displaced by 90° with respect to the two bayonet webs 12, preferably two locking webs 16 in case of two bayonet webs 12. The locking webs 16 are preferably arranged in an inclined manner in an insertion direction RE of the nut element 10. If the nut element 10 is inserted into the keyhole geometry 90, the bayonet webs 12 reach through the cutouts 92. At the same time, the locking webs 16 rest against the surface of the first component A between the cutouts 92 and generate a preferred spring pretension on the nut element 10 opposite to the insertion direction RE.

As soon as the nut element 10 has been rotated around its longitudinal axis, the bayonet webs 12 lock at a side of the first component A which faces away from the retaining collar 14. While the bayonet webs 12 are rotated out of the cutouts 92 for fastening the nut element 10 in the keyhole 90, the locking webs 16 are preferably rotated into the cutouts 92. Due to the preferred inclined arrangement of the locking webs 16, same lock into the cutouts 92, thereby preventing a future rotation of the nut element 10 around its longitudinal axis.

In order to rotate the nut element 10, the retaining collar 14 is preferably interrupted at least at two locations, in order to provide an engagement 15 for a rotating tool.

Preferably, the nut element 10 is configured annularly in combination with the bayonet webs 12 and the locking webs 16.

According to a further preferred embodiment of the nut element 10 (not shown), same comprises an outer thread instead of the bayonet webs 12 and locking webs 16 on a radial outside, so as to be fastened in a thread opening of the first component A.

By that, the annular nut element 10 is screwed into a thread opening of the first component A until the retaining collar 14 rests against the component surface of the first component A. Thus, the outer thread in combination with the retaining collar 14 form a frictional anti-rotation security. This anti-rotation security is provided in the embodiment of FIG. 1 by means of the combination of bayonet webs 12 and locking webs 16 as a form fit anti-rotation security.

According to a further not shown preferred embodiment of the nut element 10, same is formed triangularly or in a polygonal way in circumferential direction so as to be inserted into a component opening in the first component A of a complementary form. The angular form of the nut element 10 provides for an anti-rotation security of the nut element 10 within the component opening O1 relative to the first component A.

In order to retain the angular nut element 10 in the component opening O1, a latching structure (not shown) is provided in the direction of the axial insertion direction RE below the retaining collar 14. The preferred latching structure latches the nut element 10 preferably in a friction-fit and form-fit manner in the component opening O1.

The nut element 10 comprises a passage channel 18, at the radial inside 20 of which an inner thread or an inner nut thread 22 of a first thread direction is arranged.

In the illustrated embodiment, the nut element 10 furthermore comprises a nose 24 projecting in axial direction. In the illustrated embodiment, the nose 24 is arranged at one of the two locking webs 16. Alternatively, the nose 24 can also be arranged at the retaining collar 14.

In connection with the hollow screw 40, the nose 24 provides a transport security which prevents an unintended unscrewing or releasing of the hollow screw 40 from the nut element 10, for example during a transport, as will be described later.

Besides providing the transport security, the additional effect of the nose 24 is that in connection with the hollow screw 40, it prevents a countering between hollow screw 40 and nut element 10. The reason for that is the circumferential extension of the nose 24 and this will also be explained later when discussing the hollow screw 40.

In addition to this first anti-counter security formed by the nose 24, the nut element 10 comprises a second anti-counter security. It is formed by an abrupt end 26 of the nut thread 22. The abrupt end 26 is present adjacent to the axial end of the nut element 10 which comprises the retaining collar 14. Thus, the nut thread 22 of the nut element 10 does not end continuously adjacent to a first axial end of the nut element 10.

The hollow screw 40 comprises a hollow cylindrical shaft 42 with a first 62 and a second axial end 64. At the first axial end 62 of the shaft 42, a head 44 is provided having a drive feature 46, in particular a hexagon, and an attachment face 48 which faces towards the shaft.

The hollow cylindrical shaft 42 comprises a radial outside 50 with an adjusting thread 52. The adjusting thread 52 matches the nut thread 22 of the nut element 10 and is therefore an adjusting thread 52 of a first thread direction. It is particularly advantageous when the adjusting thread 52 also comprises an abrupt end 78, which particularly in combination with the abrupt end 26 of the nut thread 22 provides an effective second anti-counter security between hollow screw 40 and nut element 10. For this reason, the abrupt end 78 of the adjusting thread 52 is provided adjacent to the first axial end 62.

The hollow cylindrical shaft 42 comprises an inner channel 54 that is open on both sides and can be seen in the axial sectional view of FIG. 3. A fastening thread 56 of a second thread direction opposite to the first thread direction is arranged at a radial inside of the channel 54. The portion with the fastening thread 56 is also referred to as first portion or fastening portion 58. It comprises a first inner diameter matching the corresponding fastening screw 80.

In the configuration shown in FIG. 3, the fastening portion 58 is followed in axial direction by a second portion 60 with a larger inner diameter. This second portion 60 is provided at the second axial end 64 and is formed without thread.

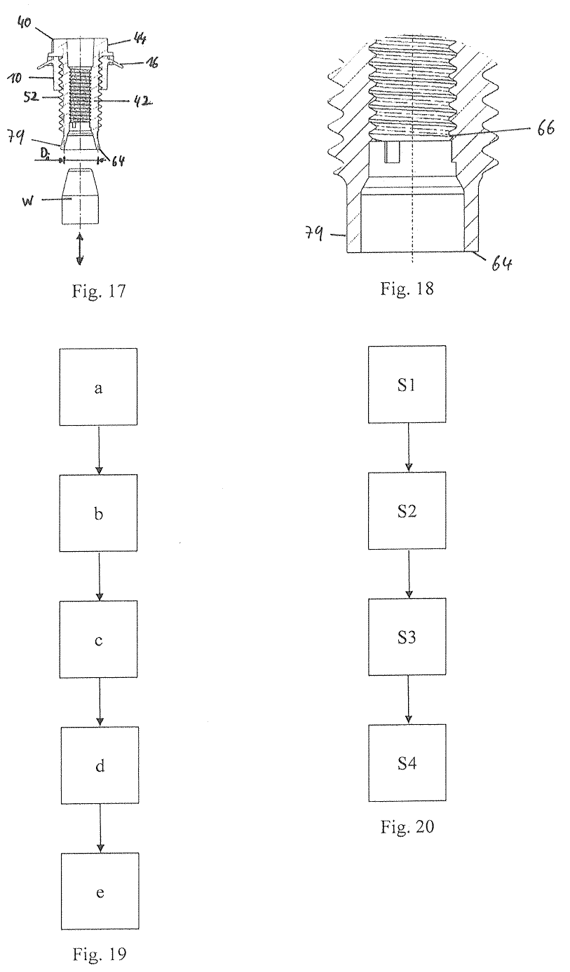

At the second axial end 64 of the hollow screw 40, which is opposite the head 44, a disassembling protection 79 of the hollow screw 40 is arranged in a particularly preferred configuration, as it is shown in FIGS. 17 and 18. For reasons of clarity, the nose 24 is not illustrated.

For example, the disassembling protection 79 is made of two axial webs and is realized by a thermic expansion at the second axial end 64 of the hollow screw 40 so that the radial expansion at the second axial end 64 exceeds an inner diameter Di of the nut element 10. Instead of the axial webs, a circumferential wall is also preferred. The thermic expansion preferably takes place by adding heat or ultrasonic by means of a tool W. After the expansion, the hollow screw 40 can no longer be removed from the nut element 10 without being destroyed. With respect to this and further configurations of the disassembling protection, reference is made to the German patent application DE 10 2024 132 374.4 which has also been filed today.

Now, again with reference to the fastening portion 58 which comprises the fastening thread 56, same furthermore comprises a dragging section 66 with a dragging means. Thus, this is a dragging means integrated into the hollow screw 40. A separate dragging element or an independent dragging element, respectively, as known from the state of the art, is therefore not present.

The dragging section 66 and thus the dragging means are arranged adjacent to the second axial end 64 of the hollow screw 40. As the first axial end 62 of the hollow screw 40 comprises the head 44, the dragging section 66 and the dragging means are present remote from the head. The fastening screw 80 is screwed into the fastening thread 56 from the first axial end 62 when using the tolerance compensation arrangement 1, as will be described later. Thus, the fastening screw 80 engages the fastening thread 56 of the hollow screw with the dragging section 66 and the dragging means only at the end of the process of screwing-in.

The dragging means provides a dragging torque. Preferably, this torque is dimensioned in a way that it is larger than a releasing torque between adjusting thread 52 and nut thread 22 of the nut element 10. In comparison with the state of the art with an integrated dragging means, the dragging torque provided by the dragging means does, however, not lead to an excessive force increase in order to release the dragging connection and rotate the fastening screw 80 further into the hollow screw 40. This is made clear particularly by means of the preferred amount of the dragging torque, which is ≤0.2 Nm, preferably ≤0.1 Nm.

In the illustrated embodiment, the dragging means is provided adjacent to the second axial end 64 of the hollow screw 40 in a portion ≤360° of the course of the fastening thread 56 starting at or adjacent to the second axial end 64. Thus, this is the dragging section 66. As can particularly be seen in FIG. 3, the wording adjacent to or at the second axial end 64 refers to the fastening portion 58 with the fastening thread 56. The second portion 60 with the larger inner diameter is therefore not relevant in this context and is left aside. This emphasizes that the dragging means is present in screwing direction of the fastening screw 80 at the end of the fastening thread 56.

Furthermore, from the feature of the course of ≤360° of the fastening thread 56 depending on the thread pitch, the maximum axial extension of the dragging section 66 arises, in which the dragging means is present. If, for example, there is a thread pitch of 1.75 mm, the axial extension of the dragging section 66 is accordingly at most 1.75 mm.

The dragging means in the dragging section 66 can be provided by the fact that a depth of the fastening thread 56 is reduced and/or that the fastening thread 56 is formed at least partly with interruptions and/or the radial inside of the hollow screw 40 adjacent to the second axial end 64 is formed circumferentially and in axial direction partly or completely even. As the second portion 60 with the larger inner diameter is not considered, as is explained above, the even configuration of the radial inside refers to the fastening portion 58. The circumferential configuration which is partly even in axial direction is illustrated in FIGS. 17 and 18. Here, the even configuration is particularly present at the end of the fastening portion 58 which faces the second axial end 64 and extends in axial direction by no more than one turn of the thread course of the fastening thread 56.

As a result, the fastening thread 56 is not completely formed. Rather, the fastening screw 80 must groove or cut a part of the fastening thread 56 itself before a front end of the fastening screw 80 leaves the fastening portion 58. Here, all different configurations of the dragging means realize an effective dragging connection between hollow screw 40 and fastening screw 80. With the different configurations however, the dragging torque can be adjusted particularly to the used materials.

As first of all, the configuration of the hollow screw 40 on the inside was discussed, the configuration of the outer side will now be considered.

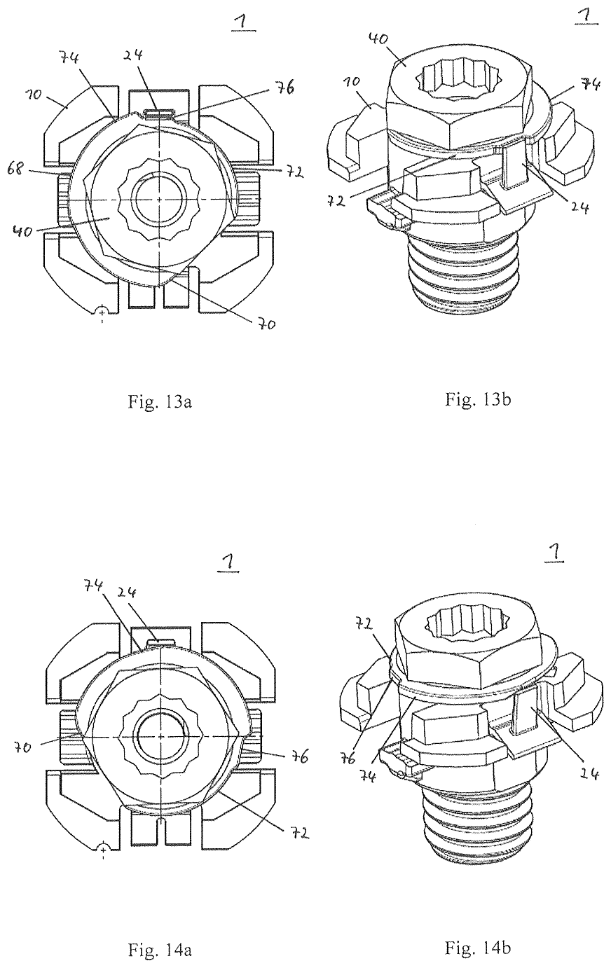

The shaft-facing attachment face 48 comprises a transport security contour 68 on the radial outside. The transport security contour 68 is configured in a way that it does not project beyond the head 44 in radial direction in a first circumferential partial portion 70, not beyond a circle encompassing the head form in a second circumferential partial portion 72 and does project beyond the encompassing circle in a third circumferential partial portion 74. The first 70, the second 72 and the third circumferential partial portion 74 are arranged one after the other in circumferential direction. A transition portion 76 is present between the second 72 and the third circumferential partial portion 74. In circumferential radial direction, the transition portion 76 is configured in a constant manner and transitions via an inclination each into the second 72 and third circumferential partial portion 74. In the illustrated embodiment, the nose 24 abuts the transition portion 76 when the hollow screw is in the completely screwed-in state into the nut element 10. This state is shown in FIGS. 6, 13a and 13b.

In connection with the nose 24 of the nut element 10, the transport security contour 68 provides a transport security so that during a transport of the tolerance compensation arrangement 1, an unintended unscrewing of the hollow screw 40 out from the nut element 10 is prevented. As explained above in connection with the nose 24, this configuration furthermore provides a first anti-counter security between the hollow screw 40 and the nut element 10. The reason for that is the width of the nose 24, i.e. its extension in circumferential direction and the resulting attachment surface at the transport security contour 68.

In this context, the above-used term “deviated in radial direction” refers to the state in which in comparison with its initial state, the nose 24 is pushed radially further to the outside due to the transport security contour 68. If for example, based on the initial state as shown in FIGS. 6, 13a and 13b, the hollow screw 40 is unscrewed from the nut element 10, the nose 24 engages the third circumferential partial portion 74 via the inclination. By that, the nose 24 is deviated or pushed radially to the outside, so that unscrewing of the hollow screw 40 becomes more difficult. This is shown in FIGS. 14a and 14b.

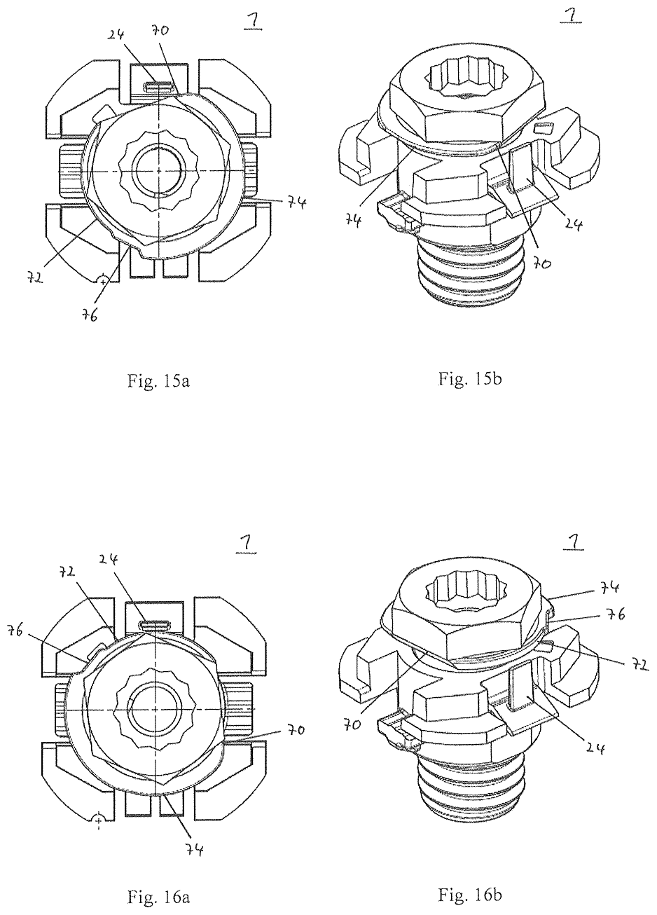

In the further course of the unscrewing, the nose 24 reaches the portion of the first circumferential partial portion 70. This is shown in FIGS. 15a and 15b. It is, however, dimensioned in a way that it no longer pushes the nose 24 radially to the outside. Therefore, the nose 24 can return to its initial state.

Due to the thread pitch and the matching dimensioning of the nose 24 in axial direction, a further unscrewing of the hollow screw 40 does no longer lead to an engagement between nose 24 and transport security contour 68, which already becomes clear based on the illustration in FIGS. 16a and 16b. Accordingly, the extension of the nose 24 in axial direction is preferably selected such that at the latest after a complete or full turn of the hollow screw 40, the transport security contour 68 can no longer come into engagement with the nose 24.

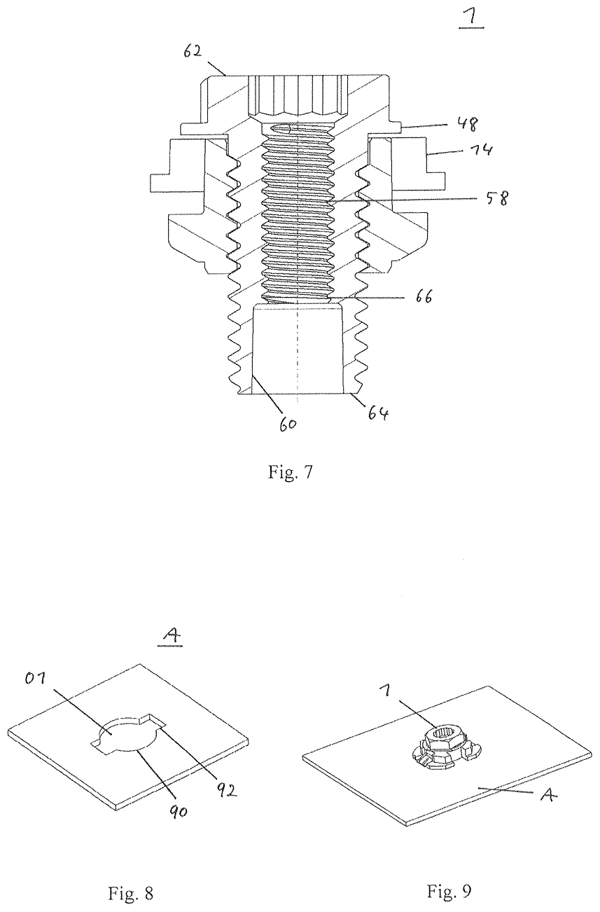

Furthermore, the adjusting thread 52 of the hollow screw 40 comprises an abrupt end 78 adjacent to the first axial end 62 of the hollow screw 40. Thus, the adjusting thread 52 does not end continuously adjacent to the first axial end 62 of the hollow screw 40. Particularly in connection with the abrupt end 26 of the nut thread 22 of the nut element 10, this leads to a second anti-counter security. This second anti-counter security provides a resistance torque which is preferably larger than the dragging torque. Thus, an additional security against countering is provided by means of the second anti-counter security. Furthermore, it is particularly the second anti-counter security which guarantees that in the completely screwed-in state of the hollow screw 40 into the nut element 10, there is a distance between the attachment surface 48 and an upper side of the retaining collar 14 of the nut element 10. Exemplary reference is made to FIG. 7 in this regard.

The advantages of the tolerance compensation arrangement 1 are, that due to the nut element 10, it can be fastened easily and quickly in the first component A. A separate dragging element is not necessary, either, so that the complexity of the tolerance compensation arrangement 1 is reduced. Furthermore, the dragging torque is dimensioned in a way that no significantly increased force effort for releasing the dragging connection is necessary, which facilitates use even more.

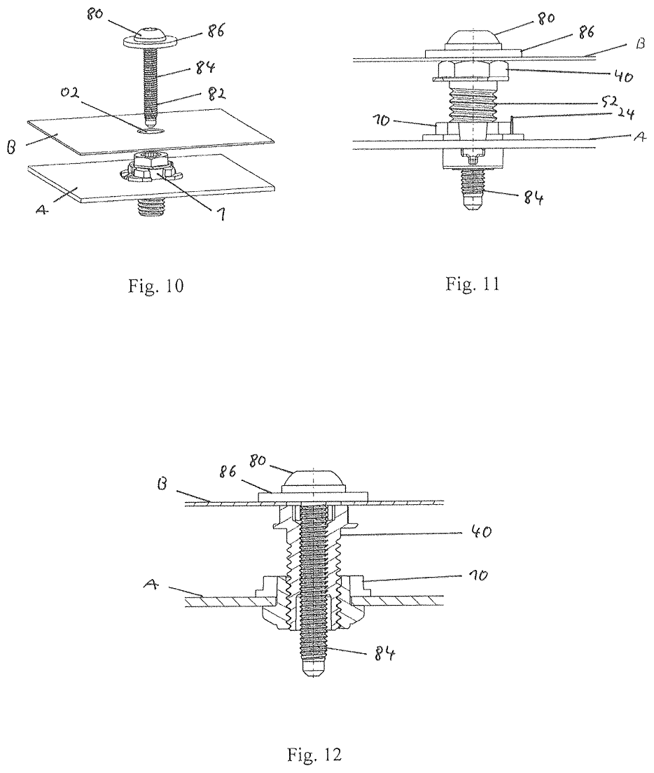

FIGS. 10 to 12 illustrate the connecting of the first A and the second component B while at the same time axial tolerances between the components A, B are compensated with the help of the tolerance compensation arrangement 1. In a first preferred step A, the nut element 10 with the hollow screw 40 preinstalled in it is fastened in the keyhole geometry 90 of the first component A. In this regard, reference is made to the above explanations as well as to FIG. 9.

Hereinafter, the second component B with a component opening O2 is arranged in a way that the component opening O2 is aligned to the channel 54 of the hollow screw 40 in the nut element 10. In this context, aligned preferably means that a center point of the component opening O2 lies on or adjacent to the central longitudinal axis of the channel 54. This is exemplary shown in FIG. 10.

Then, the fastening screw 80 is inserted through the component opening O2 of the second component B into the channel 54 of the hollow screw 40 and rotated in the second thread direction, as a screw thread 82 of the fastening screw 80 has the same thread direction as the fastening thread 56 within the hollow screw 40.

As the fastening thread 56 and the screw thread 82 match geometrically, the fastening screw 80 is screwable into the fastening thread 56 until an end of a screw shaft 84 of the fastening screw 80 which faces away from the head reaches the dragging section 66, which increases a frictional resistance between the rotating fastening screw 80 and the hollow screw 40 in comparison with the threaded engagement between screw thread 82 and fastening thread 56 (step B).

Based on the increasing friction between the fastening screw 80 and the hollow screw 40, the hollow screw 40 is corotated by the fastening screw 80. As the fastening screw 80 corotates the hollow screw 40 in the second thread direction, the hollow screw 40 is however guided in the nut thread 22 of the first thread direction with the adjusting thread 52, the rotation of the fastening screw 80 unscrews the hollow screw 40 from the nut element 10 in the direction of the second component B (step C).

As soon as the head 44 of the hollow screw 40 attaches the second component B, the rotation of the fastening screw 80 overcomes the dragging section 66 and screws itself firmly with the hollow screw 40. This state is shown in FIGS. 11 and 12.

Furthermore, the present invention also comprises the connection of both components A, B with the help of the axial tolerance compensation arrangement 1. An example for such a connection is shown in FIGS. 11 and 12 with the embodiment of the axial tolerance compensation arrangement 1.

With reference to FIG. 19, a connection method for connecting the two components A, B with the help of the axial tolerance compensation arrangement 1 to each other is summarized.

Firstly, a fastening (step a) of the nut element 10, having a hollow screw preassembled in it, in a first component opening O1, preferably a preferred keyhole geometry of the first component A, takes place, then, an arranging (step b) of the component opening O2 of the second component B opposite the fastening thread 56 of the hollow screw 40 and a screwing-in (step c) of the fastening screw 80 which extends through the component opening O2, into the fastening thread 56. After that, by rotating (step d) the fastening screw 80 and the co-rotating of the hollow screw 40 which takes place as a consequence, an extending of the tolerance compensation arrangement 1 in axial direction takes place until the tolerance compensation arrangement 1 attaches the second component B with the head 42 of the hollow screw 40. Finally, in step e, the fastening screw 80 is tightened in the fastening thread of the hollow screw 40 when the head 42 of the hollow screw 40 rests against the second component B.

As has already been mentioned above, the components of the axial tolerance compensation arrangement 1 are preferably made of plastic material, in particular the nut element 10 and the hollow screw 40. Furthermore, it is preferred that a glass fiber ratio (see above) be added to the used plastic material for the production of the nut element 10 and the hollow screw 40 so as to increase its mechanical resilience and stability.

According to a preferred embodiment of the present invention, the nut element 10 and the hollow screw 40 are produced with the help of an injection molding method. Accordingly, the manufacturing method may be summarized with the following steps, as exemplary shown in FIG. 20: providing (step S1) an injection mold for the nut element 10 and for the hollow screw 40, injection-molding (step S2) the nut element 10 and the hollow screw 40, demolding (step S3) the nut element 10 and the hollow screw 40 and preinstalling (step S4) the hollow screw 40 in the nut element 10.

The step of pre-installing (step S4) is no mandatory part of the manufacturing method and can take place later depending on the installation process of the axial tolerance compensation arrangement 1.

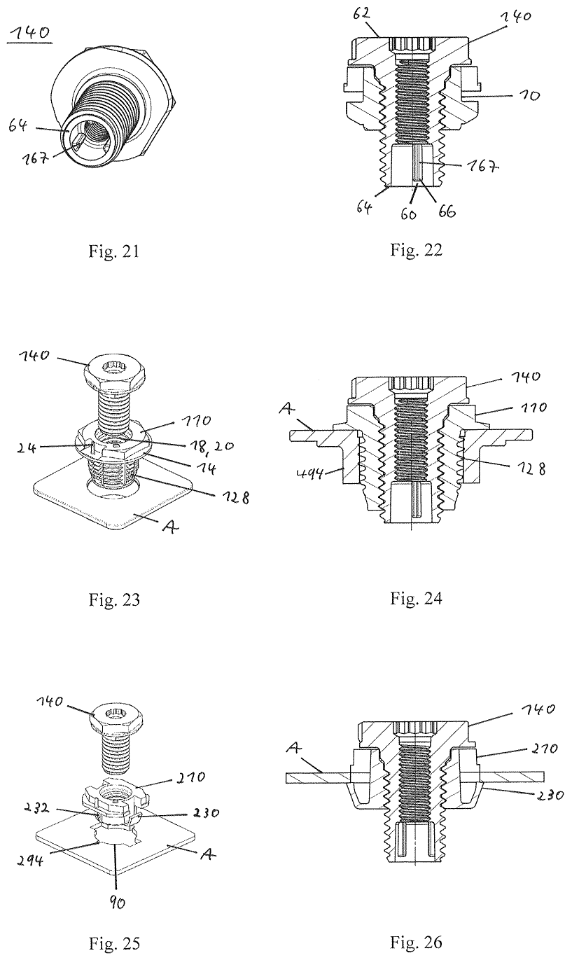

FIGS. 21 and 22 show an alternative configuration of a hollow screw 140. The basic construction of the hollow screw 140 is the same as that of the hollow screw 40, so that the hollow screw 140 also comprises a first axial end 62 as well as a second axial end 64. The second portion 60 is located at or adjacent to the second axial end 64, respectively.

In contrast to the previous configuration of the hollow screw 40, the hollow screw 140 comprises axial webs 167 in the dragging section 66. These axial webs 167 follow the portion with formed fastening thread 56.

In the illustrated embodiment, three axial webs 167 are provided which are evenly spaced from one another circumferentially. Between the axial webs 167, the wall in the fastening portion 58 springs back radially. In other words, the axial webs 167 project in radial direction from the wall in the fastening portion 58. In radial direction, the projection is dimensioned so that the fastening screw 80 comes into engagement with the axial webs 167. As however, the axial webs 167 are configured even, the fastening screw 80 must produce a thread in the axial webs 167. Thus, with this configuration, the radial inside is configured circumferentially and in axial direction partly even. The dragging torque can be adapted to the desired application via the number and/or extension of the axial webs 167 in circumferential direction.

In the illustrated configuration, the axial webs 167 additionally have a trapezoid shape in cross section. Here, the longer base side of the trapezoid shape is arranged radially outside while the shorter base side is arranged radially inside and provides the portion with which the fastening screw 80 comes into engagement in use. Thus, an extension in circumferential direction or a width of the axial webs 167 adjacent to the wall is larger than in radial direction spaced from the wall.

The axial webs 167 provide the dragging means for automatically dragging along the hollow screw 140, because only after overcoming the dragging torque does the fastening screw 80 produce a thread in the axial webs 167. Moreover, particularly the axial webs 167 which are formed like a trapezoid can also serve as a further drive means for a manual displacement of the hollow screw 140. Thus, a corresponding tool for example can engage the hollow screw 140 from the second axial end 64 in order to rotate same.

With reference to FIGS. 23 and 24, an alternatively preferred configuration of the radially outer fastening structure of a nut element 110 is discussed. The nut element 110 differs from the nut element 10 only by this changed, radially outer fastening structure.

With respect to the nut element 110, the radially outer fastening structure is provided by an outer thread 128. In this context, it is particularly preferred that same is a thread-forming or thread-grooving outer thread 128 because that way, a particularly reliable connection in particular with a first component A out of plastic material can be established.

As can be seen from a comparison with FIGS. 11 and 12, a collar or a wall portion 494 adjacent to the opening is necessary when the nut element 110, which has been designed that way, is fastened in the first component A. In particular, this applies in case of a thin-walled first component A as particularly in that way, a sufficiently large engagement surface between outer thread 128 and first component A can be provided.

FIGS. 25 and 26 show a nut element 210 with a further alternative configuration of the radially outer fastening structure. This nut element 210 also differs from the embodiment of the nut element 10 by the changed radially outer fastening structure, only.

In the present embodiment, this radially outer fastening structure is formed by a latching structure with radially springing locking noses 230. Here, two locking noses 120 are provided which are arranged opposite each other. As can particularly be seen in FIG. 25, the nut element 210 designed that way is also insertable into a keyhole geometry 90 in the first component A.

In the illustrated embodiment, the nut element 210 furthermore comprises two axially extending rigid webs 232 on the radial outside in order to prevent a rotating of the nut element 210 in the first component A during use. For this purpose, the two rigid webs 232 interact with a corresponding recess 294 in the keyhole geometry 90.

The locking noses 230 and the rigid webs 232 are mutually arranged in circumferential direction. Thus, two locking noses 230 and two rigid webs 232 each are arranged opposite each other, while an angle of 90° is enclosed between a locking nose 230 and the adjacent rigid web 232.

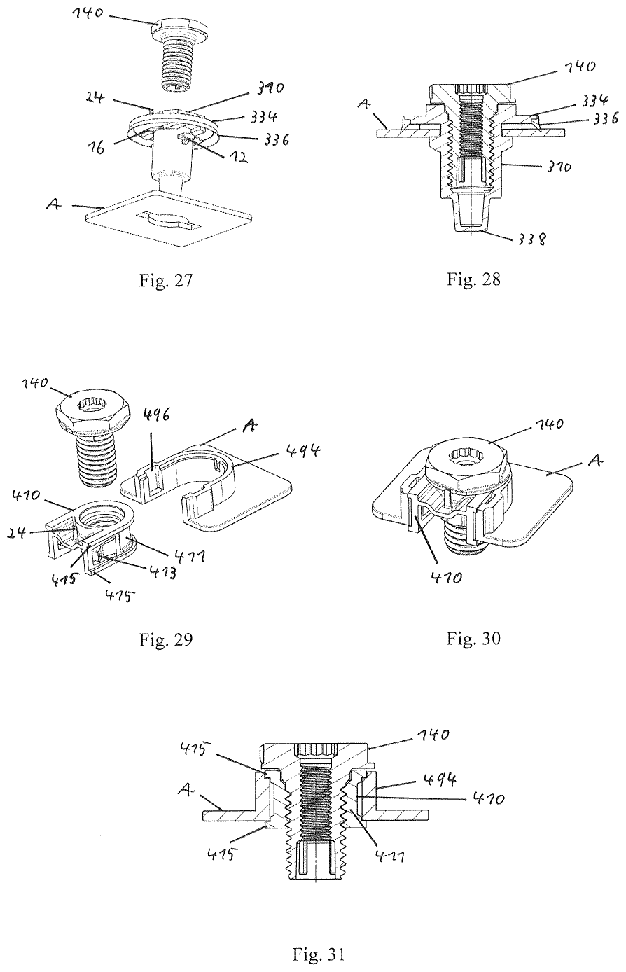

A nut element 310 with a flange 334 and a sealing lip 336 arranged to same is shown in FIGS. 27 and 28. The basic construction of the nut element 310, in particular with respect to the radially outer fastening structure, corresponds to the construction of the nut element 10.

The flange 334 is located in axial direction above the radially outer fastening structure. The sealing lip 336 extends circumferentially without interruptions from the outer end of the flange 334 in axial direction to the bottom, i.e. in the direction of the radially outer fastening structure. Thus, in use, the sealing lip 336 lies around the component opening O1 on a surface of the first component A and hinders media from entering through the component opening O1. In order to additionally guarantee that no medium can enter through the component opening O1 and in particular through the hollow screw 140 from one component side to the other component side, the nut element 310 is preferably configured with one closed side. This is illustrated by means of the closed end 338.

The sealing function which was discussed in conjunction with the nut element 310 can analogously be applied to the other nut elements 10, 110, 210 as well as to the nut element 410 which will be discussed in the following.

Finally with respect to FIGS. 29-31, a further configuration of a nut element 410 is discussed. It is particularly adapted to the case where the component opening O1 of the first component A is located at an edge of the first component A.

The component opening O1 shown in the example is present in the form of a U-shaped recess. The radially outer fastening structure of the nut element 410 is therefore provided by means of lateral locking noses 413. For this purpose, the nut element 410 comprises a U-shaped body 411 formed complementary with respect to the U-shaped recess, wherein a locking nose 413 is provided at the radial outsides of the respective leg of the U-shape. Each locking nose 413 interacts with a corresponding recess 496 in a wall portion 494 of the component opening O1 in the first component A. Here, just as in case of the outer thread 128 as radially outer fastening structure, it is also necessary that in case of a thin-walled first component A, an enlarged engagement surface for securely fastening the nut element 410 is provided.

The inserting of the nut element 410 into the component opening O1 does not take place in axial direction but from the side. In order to avoid a movement of the nut body 411 in axial direction during and after the inserting, the U-shaped nut body 411 comprises guiding projections 415. They are located on each of the axial ends of the U-shape, i.e. on top and bottom, and preferably interact with respective recesses in the wall portion 494, which can particularly be seen in FIGS. 29 and 31.

### 6. LIST OF REFERENCE SIGNS

1 axial tolerance compensation arrangement
10 nut element
12 bayonet web
14 retaining collar
15 engagement for tool
16 locking web
18 passage channel in the nut element
20 radial inside in the passage channel 18
22 nut thread of a first thread direction
24 nose
26 abrupt end of the nut thread 22
40 hollow screw
42 hollow cylindrical shaft
44 head
46 drive feature
48 attachment surface
50 radial outside of the shaft 42
52 adjusting thread of a first thread direction
54 channel
56 fastening thread of a second thread direction
58 fastening portion
60 second portion
62 first axial end
64 second axial end
66 dragging section
68 transport security contour
70 first circumferential partial portion
72 second circumferential partial portion
74 third circumferential partial portion
76 transition portion
78 abrupt end of the adjusting thread 52
79 disassembling protection
80 fastening screw
82 screw thread
84 screw shaft
86 disc
90 keyhole geometry
92 cutout
110 nut element (2^{nd} embodiment)
128 outer thread
140 hollow screw (2^{nd} embodiment)
167 axial webs
210 nut element (3^{rd} embodiment)
230 locking nose
232 rigid web
294 recess
310 nut element (4^{th} embodiment)
334 flange
336 sealing lip
338 closed end
410 nut element (5^{th} embodiment)
411 U-shaped nut body
413 locking nose
415 guiding projection
494 wall portion
496 recess in the wall portion 494
A first component
B second component
Di inner diameter of the nut element 10
O1 component opening in the first component
O2 component opening in the second component
RE insertion direction
W tool

1. An axial tolerance compensation arrangement for the automatic compensation of tolerances between a first component and a second component, comprising:
a. a nut element with a radially outer fastening structure which is fastenable in a component opening of the first component and an inner nut thread of a first thread direction,
b. a hollow screw with a head at a first axial end of the hollow screw and a hollow-cylindrical shaft having an adjusting thread at a radial outside matching the nut thread and at a radial inside a fastening thread with a second thread direction opposite to the first thread direction, wherein
c. the fastening thread interacts with a fastening screw of a second thread direction so that the first and the second component are fastenable to one another by means of the tolerance compensation arrangement, wherein
d. the fastening thread comprises a dragging means, configured so that the fastening screw is connectable with the hollow screw via the dragging means by means of a releasable dragging connection, wherein a dragging torque is ≤0.2 Nm, so that during a rotation of the fastening screw, the hollow screw is co-rotatable and movable into abutment with the second component and the fastening screw is screwable further into the hollow screw after overcoming the dragging torque and releasing the dragging connection.

2. The tolerance compensation arrangement according to claim 1, wherein the dragging means adjacent to the second axial end of the hollow screw is provided by one or more of:
a) a depth of the fastening thread decreasing,
b) the fastening thread is configured at least partly with interruptions, or
c) the radial inside of the hollow screw adjacent to the second axial end is configured circumferentially and in axial direction in part or completely even.

3. The tolerance compensation arrangement according to claim 1, furthermore comprising a transport security, configured so that during a transport of the tolerance compensation arrangement, an unintended screwing-out of the hollow screw from the nut element is prevented.

4. The tolerance compensation arrangement according to claim 3, wherein the transport security additionally comprises a first anti-counter security between the hollow screw and the nut element

5. The tolerance compensation arrangement according to claim 3, wherein the nut element comprises a nose projecting in axial direction, which in combination with a transport security contour forms the transport security at a radial outside of a shaft-facing attachment surface at the head of the hollow screw.

6. The tolerance compensation arrangement according to claim 5, wherein the transport security contour does not project beyond the head in radial direction in a first circumferential partial portion, does not project beyond a circle encompassing the head form in a second circumferential partial portion and projects beyond the encompassing circle in a third circumferential partial portion.

7. The tolerance compensation arrangement according to claim 4, further comprising a second anti-counter security between the hollow screw and the nut element

8. The tolerance compensation arrangement according to claim 7, wherein the second anti-counter security is configured:
a) adjacent to the first axial end of the hollow screw, and the adjusting thread does not end in a continuous manner, and/or
b) adjacent to a first axial end of the nut element, and the nut thread of the nut element does not end in a continuous manner.

9. The tolerance compensation arrangement according to claim 1, in which the annular nut element and the hollow screw are made of plastic material.

10. A connection of a first component and a second component spaced from same, using the tolerance compensation arrangement according to claim 1 and a fastening screw.

11. The connection according to claim 10, in which the first component has a keyhole geometry in which the nut element is arranged.

12. A connection method of a first component with a keyhole geometry with a second component having a component opening spaced from same by the tolerance compensation arrangement according to claim 1, comprising the following steps:
a. fastening the nut element, having the hollow screw preassembled in it, in the opening of the first component,
b. arranging the component opening of the second component opposite to the fastening thread of the hollow screw and screwing in a fastening screw which extends through the component opening into the fastening thread,
c. rotating the fastening screw and by that, corotating the hollow screw until same abuts the second component, and
d. tightening the fastening screw in the fastening thread when the head of the hollow screw rests against the second component.

13. (canceled)
